(19) United States
(12) Patent Application Publication
(10) Pub. No.: US 2016/0281426 A1
(43) Pub. Date: Sep. 29, 2016

(54) Tether System for a Safety Line

(71) Applicant: LATCHWAYS PLC, Devizes (GB)

(72) Inventor: Richard SHORT, Keynsham (GB)

(73) Assignee: LATCHWAYS PLC, Devizes (GB)

(21) Appl. No.: 14/777,927

(22) PCT Filed: Mar. 17, 2014
(86) PCT No.: PCT/GB2014/050841

§ 371 Date: Sep. 17, 2015

(30) Foreign Application Priority Data
Mar. 18, 2013 (GB) 1304933.3

(51) Int. Cl. E06C 7/18; A62B 35/00

(52) U.S. Cl. CPC E06C 7/186; A62B 35/0093; A62B 35/005

(57) ABSTRACT

A tether system for a safety line has an elongate guide track and stay elements arranged to move along the guide track and be carried at spaced positions along the length of a tether line. The system is typically employed in a fall arrest or protection system mounted to a structure, having an ascent/descent ladder fixed to the structure, the system including a self-retracting safety line device including a safety line, mounted at height.

### CROSS-REFERENCE TO RELATED APPLICATIONS

This application is the National Stage of International Patent Application No. PCT/GB2014/050841 filed on Mar. 17, 2014, which claims priority from British Patent Application No. GB 1304933.3 filed on Mar. 18, 2013, both of which are hereby incorporated by reference herein in their entireties.

### BACKGROUND

1. Field

The present invention relates to tether system for a safety line, particularly for a fall arrest system.

2. State of the Art

Prior art safety systems are known in which tall structures are fitted with a safety systems such as self retracting lifelines (SRLs) anchored at an elevated position on the structure. For example towers, masts, or wind turbine structures may be fitted with a SRL anchored at an elevated position toward the top of the structure. A personnel ladder is typically secured to the structure to enable personnel access to the top of the structure for maintenance or other purposes. The person secures themselves to the SRL before climbing the ladder and following ascent and subsequent descent of the ladder the person releases the SRL.

There is an issue that the SRL, when not in use, as the line in the retracted position is wound onto the SRL drum in the housing of the SRL. This ensures that the safety line is not exposed when not in use. However it means that when the person is at the foot of the structure before ascending the ladder, the attachment point at the end of the line is positioned high up at the SRL.

There are various solutions to this problem. In a first prior art system the attachment point (karabiner) at the end of the safety line is secured to an endless tether line loop mounted about a pair of pulleys one positioned at the foot of the structure and one high up toward the top of the structure. The tether line loop can be pulled by a person positioned at the foot of the structure and as the tether line moves along its path the end of the safety line connected to the tether line is pulled downwardly in so doing paying out the safety line from the SRL. When the end of the safety line is pulled down all the way to the foot of the structure the person can secure the safety line to their personal harness for ascent of the structure. Following descent, the person can unclip the safety line from the harness and ensure hat it is re-secured to the tether line. The person can then pull the tether line in the reverse direction to allow the safety line to retract back into the SRL.

In the hostile maritime environment the pulley wheels and line arrangement can become corroded and seized and therefore inoperable. Also there are problems in tensioning such systems in conditions of strong tides and powerful waves.

An alternative solution is shown in for example WO2007/128307. In this arrangement an auxiliary line is connected to the end of the safety line. When the safety line is fully retracted into the SRL housing, the length of the auxiliary line extends downwardly by a distance equivalent to the height of the structure. The user at the foot of the structure pulls on the auxiliary line in order to pull the SRL attachment karabiner downwardly paying out the safety line for attachment to the user. A disadvantage is that the auxiliary line may become tangled making subsequent automatic retraction of the safety line into the SRL difficult. If the safety line is not fully retracted following use the internal parts of the SRL may be left open to corrosion as would be the length of safety line remaining exposed.

An improved tether and safety system has been devised which provides advantages over known prior art systems.

According to the present invention, there is provided a tether system for a safety line, the tether system comprising:
an elongate guide track;
a plurality of stay elements arranged to move along the guide track and be carried at spaced positions along the length of a tether line.

It is preferred that the system includes a tether line for connection to the safety line.

The elongate guide track is preferably provided with bracket fixing means for mounting the guide track, proximate opposed ends, to a structure.

In certain embodiments, it may be preferred that the elongate track is mounted in tension. In such an embodiment, it may be preferred that the system includes a tensioning arrangement for imparting, or varying, tension into the elongate guide track.

In certain embodiments the guide track may comprise a flexible elongate line such as a length of webbing, ribbon, cable or rope.

It is preferred that the guide track is a fixed position guide track, As opposed to a moving pulley system, for example.

It is preferred that the stay elements include a formation arranged to permit sliding travel with respect to the track element whilst inhibiting parting or separation of the stay elements and guide track.

The stay elements may include a channel or slot formation arranged to permit sliding travel with respect to the track element.

It is preferred that the stay elements are provided with means for securing to the tether line. For example the stay elements may be provided with holes through which the tether line extends for securing. The holes may be dimensioned such that the stays do not slide along the tether line, but rather are secured in position and move with the tether line.

Typically the elongate guide track is oriented substantially vertically.

Typically, the elongate guide track is mounted to or adjacent to a ladder structure.

According to a related aspect, the invention provides a fall arrest or protection system mounted to a structure, having an ascent/descent ladder fixed to the structure, the system including a self-retracting safety line device including a safety line, mounted at height; an elongate guide track extending along at least a part of the length of the ladder; a plurality of stay elements arranged to move along the guide track and be carried at spaced positions along the length of a tether line connected to the safety line.

The invention will now be further described, by way of example only, with reference to the accompanying drawings.

### BRIEF DESCRIPTION OF THE DRAWINGS

FIG. 1 is a schematic perspective view of a tether line system in accordance with the invention in a home position (safety line fully retracted).

FIG. 2 is a view similar to the view of FIG. 1 but with the tether line in a deployed configuration (safety line fully payed out);

FIG. 3 is a detailed view of a part of the system in the condition of FIG. 1 in a home position (safety line fully retracted);

FIG. 4 is a detailed view of a part of the system;

FIG. 5 is a detailed view of a part of the system in the condition of FIG. 2, in which the tether line is in a deployed configuration (safety line fully payed out).

### DETAILED DESCRIPTION

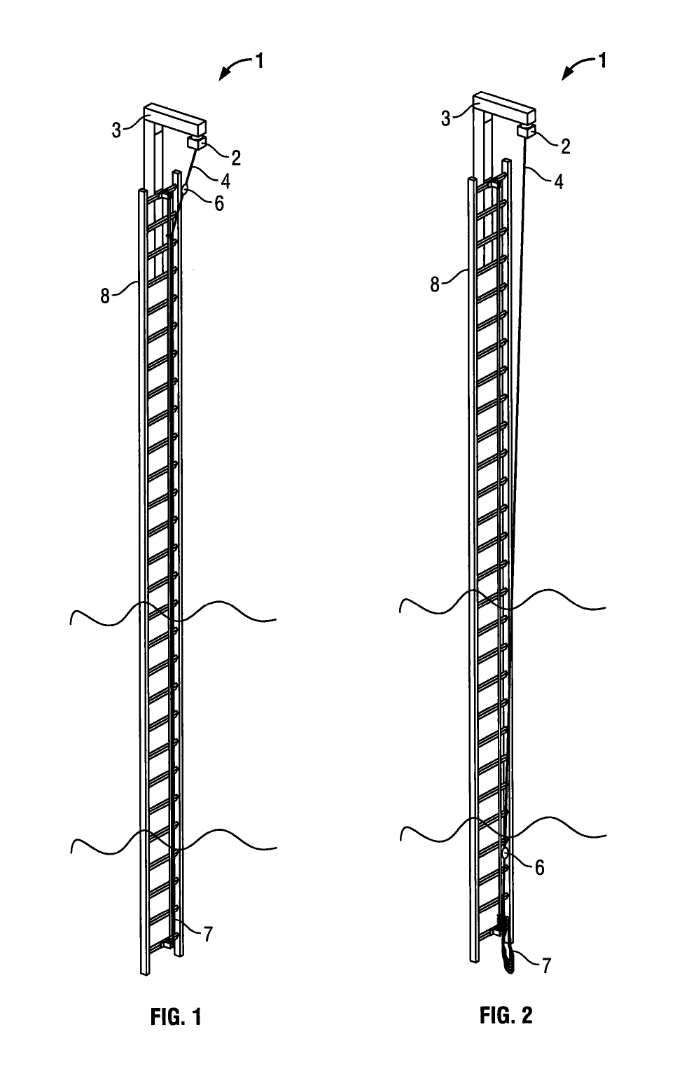

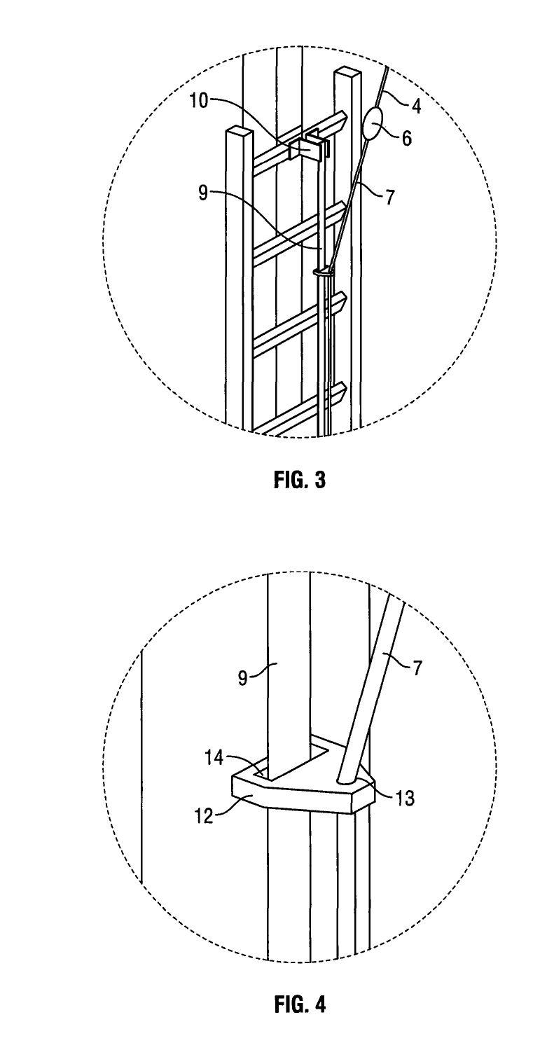

Referring to the drawings there is shown a fall arrest arrangement 1 for use in protection of personnel when ascending and descending relatively high structures, such as towers, masts or the like. The system is particularly suited to use with offshore structures. In FIGS. 1 and 2 the structure to which the fall arrest system is fixed is not shown for purposes of clarity. There is shown an access ladder 8 having a structural support beam 3 mounted at the top.

A self retracting lifeline (SRL) 2 as known in the art is suspended from the beam 3 at the top of the structure and provides a safety line 4 that can be drawn out from a housing of the SRL 2. The safety line 4 is wound on a drum provided internally of the SRL housing. A return spring line retracting device is provided internally of the housing and the SRL 2 includes an energy absorber device in order to absorb energy in the event of a personnel fall situation. These features are known in the art of SRLs. At the free end of the safety line 4 there is provided a Karabiner 6 for attachment to a safety harness worn by the user.

A tether line system is also secured to the structure. The tether line system includes a tether line 7 which is secured at an upper end to the karabiner 6 attached to the safety line 4. The lower end of the tether line is secured at the base of the ladder 8. A guide track comprising tensioned length of webbing 9 is anchored to the ladder 8 at the top and bottom of the ladder by means of a fixing bracket 10, 11, such that the webbing guide track extends substantially the full length of the ladder 8. Typically one of the brackets is provided with means for adjusting the tensioning in the webbing guide track 9. As an alternative to a flexible tensioned guide track a rigid track could be used.

Secured to the tether line 7 at spaced locations along its length are plastic stay clips 12. The stay clips 12 are provided with apertures 13 through which the line passes. The line is secured to the stay clips wither by means of bonding or an interference fit between the tether line and the aperture 13 in the stay clip 12, which is typically sufficient to prevent dislodgement. The plastic stay clips 12 are also provided with a slot 14 through which the webbing guide track 9 is slotted. The slot 14 is dimensioned to permit sliding travel of the stay clip 12 along the webbing guide track 9, whilst preventing parting or separation of the stay clip 12 away from the webbing guide track 9.

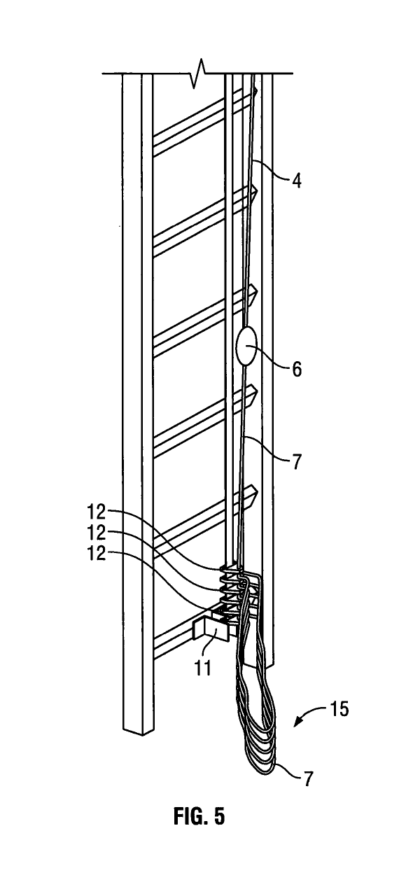

When the arrangement is configured in the home position, as shown in FIG. 1 the safety line 4 is retracted fully in to the SRL 2 and the karabiner is positioned at the uppermost part of the ladder. As shown in FIG. 2, the tether line is connected to the karabiner 6 and the uppermost stay clip is positioned near the uppermost portion of the webbing guide track 9, near the bracket 10. In order to retrieve the safety line from the SRL 2 whilst the user is positioned at the foot of the ladder 8, the user pulls down the tether line 7. As the tether line is increasingly lowered to draw the karabiner 6 and attached safety line 4 downwardly, the successive stay clips 12 collect adjacent with one another on the webbing guide track 9 at the foot of the ladder and the intervening lengths of the tether line 7 form tidy loops 15. This is shown most clearly in FIG. 5. This provides for tether line management in the lifeline deployed configuration. The advantage of this arrangement is that there is controlled gathering of the tether line at the foot of the structure which aids in retraction of the safety line 4 back towards the SRL 2 under the influence of the refraction spring of the SRL. The spring is relatively weak and tangling of the tether line 7 can result in the spring not being sufficient draw the safety line 4 completely back into the SRL 2 housing which can result in damage to the integrity of the SRL and safety in 4 in harsh environments (for example maritime environments). The arrangement provides a ‘low friction’ solution. The arrangement provides for installation and less maintenance than using the pulley solution, whilst providing advantages over known non-pulley systems.

1. A tether system for a safety line, the tether system comprising:
an elongate guide track;
a plurality of stay elements arranged to move along the guide track and be carried at spaced positions along the length of a tether line.

2. A tether system according to claim 1, further comprising a tether line for connection to the safety line.

3. A tether system according to claim 1, wherein the elongate guide track is provided with bracket fixing means for mounting the guide track, proximate opposed ends, to a structure.

4. A tether system according to claim 1, wherein the elongate track is mounted in tension.

5. A tether system according to claim 4, further comprising a tensioning arrangement for imparting, or varying, tension into the elongate guide track.

6. A tether system according to claim 1, wherein the guide track comprises a flexible elongate line such as a length of webbing, ribbon or rope.

7. A tether system according to claim 1, wherein the guide track is a fixed position guide track.

8. A tether system according to claim 1, wherein the stay elements include a formation arranged to permit sliding travel with respect to the guide track whilst inhibiting parting or separation of the stay elements and guide track.

9. A tether system according to claim 1, wherein the stay elements include a channel or slot formation arranged to permit sliding travel with respect to the guide track.

10. A tether system according to claim 1, wherein the stay elements are provided with means for securing to the tether line.

11. A tether system according to claim 10, wherein the stay elements are provided with holes through which the tether line extends for securing.

12. A tether system according to claim 1, wherein the elongate guide track is oriented substantially vertically.

13. A tether system according to claim 1, wherein the elongate guide track is mounted to or adjacent to a ladder structure.

14. A fall arrest or protection system comprising:
a tether system according to claim 1 in combination with a self-retracting safety line device including a safety line.

15. A fall arrest or protection system mounted to a structure, the system comprising:
an ascent/descent ladder fixed to the structure;
a self-retracting safety line device including a safety line, mounted at height;
an elongate guide track extending along at least a part of the length of the ladder; and
a plurality of stay elements arranged to move along the guide track and be carried at spaced positions along the length of a tether line connected to the safety line.
